(19) United States
(12) Patent Application Publication
(10) Pub. No.: US 2026/0228890 A1
(43) Pub. Date: Aug. 6, 2026

(54) SYSTEMS AND METHODS FOR ENHANCING QUALITY CONTROL IN MEDICAL IMAGE SEGMENTATION THROUGH INTENTIONAL ERROR INTRODUCTION

(71) Applicant: Heartflow, Inc., Mountain View, CA (US)

(72) Inventors: Michiel SCHAAP, Oegstgeest (NL); Samuel GERBER, Fayetteville, WV (US); Peter Kersten PETERSEN, Palo Alto, CA (US); Matthew SINCLAIR, London (GB); Kelly JENNINGS, Redwood City, CA (US); Timothy A. FONTE, San Francisco, CA (US)

(21) Appl. No.: 19/450,191

(22) Filed: Jan. 15, 2026

Related U.S. Application Data
(60) Provisional application No. 63/745,917, filed on Jan. 16, 2025.

(51) Int. Cl. G06T 7/00; G06T 7/11

(52) U.S. Cl. CPC G06T 7/0012; G06T 7/11; G06T 2207/20081; G06T 2207/20112

(57) ABSTRACT

Systems and methods for enhancing quality control in medical image segmentation is provided. A medical image may be automatically segmented to obtain a segmentation, or quantifying objects may be detected in the medical image to obtain one or more object detections. A predetermined error may be introduced into the segmentation or one or more object detections. The segmentation or one or more object detections may be provided for output. It may be determined whether the predetermined error was detected in the segmentation or one or more object detections.

### CROSS-REFERENCE TO RELATED APPLICATIONS

This application claims priority to U.S. Provisional Application No. 63/745,917, titled “SYSTEMS AND METHODS FOR ENHANCING QUALITY CONTROL IN MEDICAL IMAGE SEGMENTATION THROUGH INTENTIONAL ERROR INTRODUCTION,” filed Jan. 16, 2025, which is hereby incorporated by reference in its entirety.

### FIELD OF INVENTION

The present disclosure relates to medical image analysis and quality control systems, and more particularly to systems and methods for enhancing quality control in medical image segmentation through the deliberate introduction of predetermined errors to assess and improve human reviewer performance.

### BACKGROUND

Medical imaging technologies, including computed tomography (CT), magnetic resonance imaging (MRI), and ultrasound, have become integral to modern healthcare for diagnosis, prognosis, and treatment planning across a wide range of medical conditions. The analysis of medical images frequently involves segmentation tasks, where anatomical structures or regions of interest are delineated, as well as object detection and quantification tasks that identify and measure specific features within the images.

Automated algorithms for medical image segmentation, object detection, and quantification have advanced considerably, offering the potential to improve efficiency and consistency in medical image analysis workflows. These automated systems can process large volumes of imaging data and provide initial analyses that human reviewers subsequently examine and verify. In clinical settings, human oversight of automated results remains a standard practice to help ensure accuracy before the results inform patient care decisions.

However, the increasing sophistication and reliability of automated systems can present challenges for maintaining effective human oversight. When automated systems consistently produce accurate results, human reviewers may become less attentive during the review process, potentially reducing their ability to identify errors when they do occur. This phenomenon of reduced vigilance during routine review tasks is recognized across various fields where humans monitor automated systems.

Quality control processes in medical image analysis benefit from mechanisms that can assess and maintain the performance of human reviewers over time. Training programs for personnel involved in reviewing automated segmentations and detections can be enhanced when specific performance data is available. Additionally, understanding the relative strengths and limitations of human reviewers compared to automated systems can inform decisions about workflow design and resource allocation.

Systems and methods that address the maintenance of human vigilance and the assessment of reviewer performance in medical image analysis workflows continue to be developed and refined.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for enhancing quality control in medical image segmentation is provided. The method includes automatically segmenting a medical image to obtain a segmentation, or detecting or quantifying objects in the medical image to obtain one or more object detections. The method further includes introducing a predetermined error into the segmentation or one or more object detections. The method also includes providing the segmentation or one or more object detections for output. The method additionally includes determining whether the predetermined error was detected in the segmentation or one or more object detections. The method further includes, if the predetermined error is not detected, sending an alert, recording a mistake, and/or determining a corrected segmentation.

According to other aspects of the present disclosure, the method may include one or more of the following features. The predetermined error may be introduced using a secondary segmentation model trained to predict locations and types of corrections required. The method may further include a training phase comprising training an initial automatic segmentation model to achieve accuracy beyond a predetermined threshold in segmenting a structure of interest, defining a process and training one or more administrators to identify and correct critical errors, collecting data of captured instances where the administrators correct critical errors, and training the secondary segmentation model using the collected data to predict the locations and types of corrections required. The method may further include an inference phase comprising segmenting the structure of interest using the initial automatic segmentation model to create an initial segmentation, applying the secondary segmentation model to identify areas where the initial segmentation requires improvement, determining which critical corrections should be implemented based on human input, and applying the identified corrections based on determined criteria while leaving a specified number of errors uncorrected. The method may further include an error detection and evaluation phase comprising, if a critical error is intentionally left uncorrected and remains undetected, presenting the error for inspection, showing an automatically corrected segmentation, and recording the critical error along with an identifier for performance assessment and targeted training purposes. The predetermined error may be introduced by an automatic segmentation method that produces one or more variant segmentations, including one or more implausible segmentations. The method may further include a training phase comprising training an automatic segmentation model that produces multiple plausible segmentations along with uncertainties. The method may further include an inference phase comprising segmenting a structure of interest to provide a standard segmentation, and introducing errors by modifying certain regions to create a segmentation variant that deviates significantly from the standard segmentation. The method may further include an error detection and evaluation phase comprising, if a critical error is undetected, presenting the error for inspection, showing an automatically corrected segmentation, and recording the critical error along with an identifier for performance assessment and targeted training purposes. The predetermined error may be introduced using expert knowledge to modify a segmentation. The method may further include a training phase comprising training a standard segmentation model, and generating additional segmentations by employing expert or prior knowledge to modify the segmentation model, including one or more of geometric models. The one or more geometric models may be based on an idealized radius to disregard regions of stenosis, or omission of critical predictions including calcified plaque in a lumen outer wall segmentation. The method may further include an inference phase comprising applying the segmentation model, and employing an auxiliary model to introduce critical errors. The method may further include an error detection and evaluation phase comprising, if a critical error remains undetected, presenting the error for examination, displaying an automatically corrected segmentation, and documenting the critical error along with an identifier for performance assessment and targeted training purposes.

According to another aspect of the present disclosure, a system for enhancing quality control in medical image segmentation is provided. The system includes one or more processors. The system further includes a memory storing instructions that, when executed by the one or more processors, cause the system to automatically segment a medical image to obtain a segmentation, or detect or quantify objects in the medical image to obtain one or more object detections. The instructions further cause the system to introduce a predetermined error into the segmentation or one or more object detections. The instructions also cause the system to provide the segmentation or one or more object detections for output. The instructions additionally cause the system to determine whether the predetermined error was detected in the segmentation or one or more object detections. The instructions further cause the system to, if the predetermined error is not detected, send an alert, record a mistake, and/or determine a corrected segmentation.

According to other aspects of the present disclosure, the system may include one or more of the following features. The predetermined error may be introduced using a secondary segmentation model trained to predict locations and types of corrections required. The predetermined error may be introduced by an automatic segmentation method that produces one or more variant segmentations, including one or more implausible segmentations. The predetermined error may be introduced using expert knowledge to modify a segmentation, including using one or more geometric models based on an idealized radius to disregard regions of stenosis, or omission of critical predictions including calcified plaque in a lumen outer wall segmentation. The instructions may further cause the system to record the predetermined error along with an identifier for performance assessment and targeted training purposes.

According to another aspect of the present disclosure, a non-transitory computer-readable medium storing instructions is provided. The instructions, when executed by one or more processors, cause the one or more processors to automatically segment a medical image to obtain a segmentation, or detect or quantify objects in the medical image to obtain one or more object detections. The instructions further cause the one or more processors to introduce a predetermined error into the segmentation or one or more object detections. The instructions also cause the one or more processors to provide the segmentation or one or more object detections for output. The instructions additionally cause the one or more processors to determine whether the predetermined error was detected in the segmentation or one or more object detections. The instructions further cause the one or more processors to, if the predetermined error is not detected, send an alert, record a mistake, and/or determine a corrected segmentation.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts an exemplary computer environment for performing techniques described herein, according to aspects of the present disclosure.

FIG. 2 illustrates a flowchart for a method for enhancing quality control in medical image segmentation, according to aspects of the present disclosure.

FIG. 3 illustrates a flowchart for a method for enhancing quality control in medical image segmentation using a secondary segmentation model, according to an embodiment.

FIG. 4 illustrates a flowchart for a method for enhancing quality control in medical image segmentation using segmentation variability, according to an embodiment.

FIG. 5 illustrates a flowchart for a method for enhancing quality control in medical image segmentation, according to aspects of the present disclosure.

FIG. 6 illustrates a block diagram of a system for performing techniques described herein, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to systems and methods for enhancing quality control in medical image segmentation through intentional error introduction. As automated algorithms for medical image segmentation, object detection, quantification, and characterization become increasingly sophisticated, human reviewers may become complacent during the review process. Such complacency may lead to oversights that affect the reliability of diagnoses, prognoses, and treatment plans. The systems and methods described herein address this concern by deliberately introducing predetermined errors into segmentations, detected objects, or quantifications. These predetermined errors are tracked and monitored to determine whether a human reviewer successfully identifies the predetermined errors.

In some cases, the systems and methods described herein may automatically segment a medical image, detect objects in a medical image, or quantify objects in a medical image. A predetermined error may then be introduced into the segmentation or object detection. The type of error introduced may be determined by a human, by an automated system, or by a combination of human and automated determination. The segmentation or object detection may then be presented to a human observer for inspection. If the observer fails to detect or correct the predetermined error, the systems and methods may alert the user, record the mistake, and present the error along with a corrected segmentation to the observer.

The recorded quality review errors may be utilized for various purposes. In some cases, missed errors may serve as measurable indicators of an individual's performance in quality review tasks. This data may be used to identify areas for improvement, set performance goals, and track progress over time. In some cases, the types and frequency of errors may be analyzed to design training programs that address weaknesses and enhance the skills of quality review staff. In some cases, errors made by human reviewers may be compared to errors potentially missed or falsely introduced by automated systems. Such analysis may help determine whether human review adds value in terms of error detection and correction, or whether an automated approach may be more suitable in certain scenarios.

The systems and methods described herein differ from concepts in active learning, reinforcement learning, and human-in-the-loop learning. In those areas, the accuracy of a model is increased during training through various methods of incorporating human knowledge. The systems and methods described herein do not aim to enhance the performance of a target model. Rather, the systems and methods described herein develop methodologies to introduce errors deliberately. These errors are introduced to assess human performance in interacting and collaborating with a target model. The systems and methods described herein may utilize a statistical model similar to a target model, but such utilization is not required. Various sources of expert and prior knowledge may be employed to introduce known errors for the purpose of evaluating human interaction with a target model.

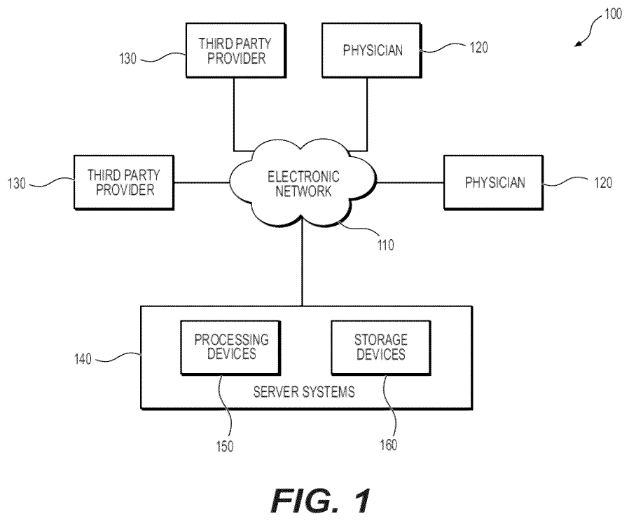

Referring to FIG. 1, an environment 100 may be implemented for performing the quality control techniques described herein. The environment 100 may include server systems 140 connected to an electronic network 110, such as the Internet. A plurality of physicians 120 and third party providers 130 may be connected to the electronic network 110 through one or more computers, servers, and/or handheld mobile devices. In some cases, a physician 120 may represent a hospital or a computer system of a hospital. In some cases, a third party provider 130 may represent an imaging center or other healthcare facility.

With continued reference to FIG. 1, physicians 120 and/or third party providers 130 may create or otherwise obtain medical images of one or more patients. The medical images may include images of cardiac, vascular, and/or organ systems. In some cases, physicians 120 and/or third party providers 130 may obtain patient-specific information, such as age, medical history, blood pressure, blood viscosity, and other types of patient-specific information. Physicians 120 and/or third party providers 130 may transmit the patient-specific information and medical images to server systems 140 over the electronic network 110.

As further shown in FIG. 1, server systems 140 may include one or more storage devices 160 for storing images and data received from physicians 120 and/or third party providers 130. The storage devices 160 may be considered to be components of a memory of the server systems 140. Server systems 140 may also include one or more processing devices 150 for processing images and data stored in the storage devices 160 and for performing any computer-implementable process described in this disclosure. Each of the processing devices 150 may be a processor or a device that includes at least one processor.

In some cases, server systems 140 may comprise and/or utilize a cloud computing platform with scalable resources for computations and/or data storage. Server systems 140 may run an application for performing the quality control methods described herein on the cloud computing platform. In such cases, outputs may be transmitted to another computer system, such as a personal computer, for display and/or storage. Other examples of computer systems for performing the methods described herein include desktop computers, laptop computers, and mobile computing devices such as tablets and smartphones.

The methods described herein may be applied to various image modalities. In some cases, the methods may be applied to computed tomography (CT) images. In some cases, the methods may be applied to magnetic resonance imaging (MRI) images. In some cases, the methods may be applied to ultrasound images. The methods may also be applied to other imaging modalities used in medical diagnosis and treatment planning.

The methods described herein may be applied to various structures of interest. In some cases, the methods may be applied to coronary arteries for diagnosis, prognosis, or treatment planning of coronary artery disease. In some cases, the methods may be applied to the liver. In some cases, the methods may be applied to structures in the brain. The methods may also be applied to other anatomical structures relevant to medical diagnosis and treatment.

The type of error introduced into a segmentation or object detection may be determined in various ways. In some cases, the type of error may be determined by a human. In some cases, the type of error may be determined by an automated system. In some cases, the type of error may be determined by a combination of human and automated determination. The determination of error type may take into account the clinical application, the structure of interest, and the types of errors that are most relevant for assessing human reviewer performance.

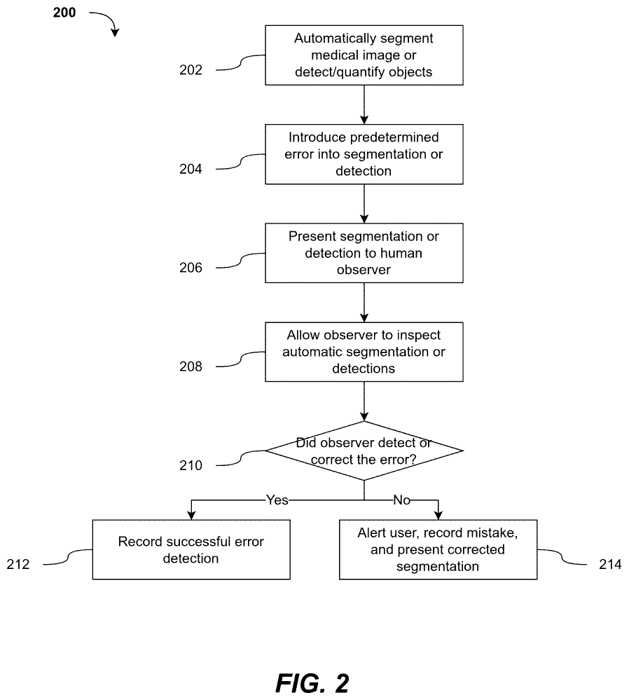

Referring to FIG. 2, a method 200 for enhancing quality control in medical image segmentation is illustrated. The method 200 provides a structured approach to maintaining human vigilance during the review of medical image segmentations by deliberately introducing tracked errors and monitoring whether human reviewers successfully identify the tracked errors.

The method 200 begins with a step 202, where a medical image is automatically segmented to obtain a segmentation, or objects in the medical image are detected or quantified to obtain one or more object detections. In some cases, the automatic segmentation may be performed by the processing devices 150 of the server systems 140. The automatic segmentation or object detection may be performed using trained machine learning models or other automated algorithms. The medical image may be received from physicians 120 or third party providers 130 over the electronic network 110.

With continued reference to FIG. 2, the method 200 then proceeds to a step 204, where a predetermined error is introduced into the segmentation or one or more object detections. The predetermined error may be introduced by a human, by an automated system, or by a combination of human and automated determination. The type of predetermined error introduced may be selected based on the clinical application, the structure of interest, or the types of errors that are relevant for assessing human reviewer performance.

Following step 204, the method 200 moves to a step 206, where the segmentation or one or more object detections are provided for output. In some cases, the segmentation or one or more object detections may be presented to a human observer through a display interface. The human observer may be a physician 120, a radiologist, or other medical professional responsible for reviewing the segmentation or object detections.

As further shown in FIG. 2, the method 200 continues to a step 208, where the observer is allowed to inspect the automatic segmentation or one or more object detections. During step 208, the human observer may review the segmentation or object detections and may make corrections or modifications as appropriate. The human observer may use various tools and interfaces to examine the segmentation or object detections in detail.

The method 200 then reaches a step 210, which is a decision point that determines whether the predetermined error was detected in the segmentation or one or more object detections. At step 210, the system determines whether the observer detected or corrected the predetermined error that was introduced at step 204. This determination may be made by comparing the observer's corrections or modifications to the known location and type of the predetermined error.

If the observer successfully detected or corrected the predetermined error at step 210, the method 200 proceeds along a Yes branch to a step 212, where the successful error detection is recorded. The recording of successful error detection may be stored in the storage devices 160 of the server systems 140. The recorded successful detection may be associated with an identifier of the human observer for performance tracking purposes.

If the observer failed to detect or correct the predetermined error at step 210, the method 200 proceeds along a No branch to a step 214. At step 214, the user is alerted, a mistake is recorded, and/or a corrected segmentation is determined. In some cases, the predetermined error and the corrected segmentation may be presented to the observer. The recorded mistake may be stored in the storage devices 160 along with an identifier of the human observer.

The recorded quality review errors from the method 200 may be utilized for various purposes. In some cases, the recorded quality review errors may be utilized for human performance management. The missed errors may serve as measurable indicators of an individual's performance in quality review tasks. This data may be used to identify areas for improvement, set performance goals, and track progress over time for individual reviewers.

In some cases, the recorded quality review errors may be utilized for development of tailored training programs. By analyzing the types and frequency of errors, training programs may be designed to address weaknesses and enhance the skills of quality review staff. Categorization of error types may enable module-based training courses for the improvement of detection of errors of a given type. Such training may be included as part of continuing education or retraining programs for human experts.

In some cases, the recorded quality review errors may be utilized for comparative analysis of human versus automated methods. The errors made by human reviewers may be compared to errors potentially missed or falsely introduced by automated systems. This analysis may help determine whether human review adds value in terms of error detection and correction, or whether an automated approach may be more suitable in certain scenarios. Such comparative analysis may lead to informed decisions about the use of automated quality control methods.

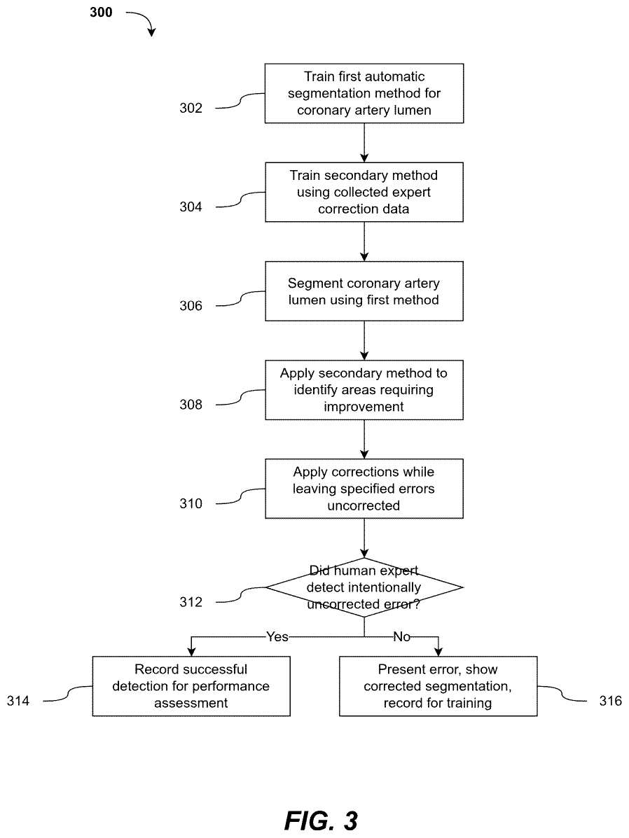

Referring to FIG. 3, a method 300 for enhancing quality control in medical image segmentation using a secondary segmentation model is illustrated. The method 300 provides a structured approach for introducing predetermined errors into medical image segmentations using a secondary segmentation model trained to predict locations and types of corrections required. The method 300 enables performance assessment and targeted training for quality control personnel by tracking whether human reviewers successfully identify predetermined errors.

The method 300 begins with a step 302, where a first automatic segmentation method is trained for segmenting a structure of interest. During step 302, an initial automatic segmentation model is trained to achieve accuracy beyond a predetermined threshold in segmenting the structure of interest. In some cases, the structure of interest may be a coronary artery lumen. The first automatic segmentation method may achieve high accuracy in segmenting the structure of interest, though the first automatic segmentation method may not achieve a perfect segmentation.

With continued reference to FIG. 3, the method 300 then proceeds to a step 304, where a secondary method is trained using collected expert correction data. During step 304, a process is defined and one or more administrators are trained to identify and correct critical errors that impact intended clinical applications. Data is collected of captured instances where the administrators correct critical errors. During the collection of data, errors may be labeled and categorized. The secondary segmentation model is trained using the collected data to predict the locations and types of corrections required. The secondary segmentation method is trained to emulate the behavior of human experts in focusing on critical error correction.

Following the training phases, the method 300 moves to a step 306, where the structure of interest is segmented using the first method. During step 306, the structure of interest is segmented using the initial automatic segmentation model to create an initial segmentation. In some cases, the coronary artery lumen may be segmented using the first automatic segmentation method.

As further shown in FIG. 3, the method 300 then continues to a step 308, where the secondary method is applied to identify areas requiring improvement in the initial segmentation. During step 308, the secondary segmentation model is applied to identify areas where the initial segmentation requires improvement. The secondary segmentation model may predict locations and types of corrections that are required based on the training data collected from human expert corrections.

The method 300 proceeds to a step 310, where corrections are applied while leaving specified errors uncorrected. During step 310, a determination is made as to which critical corrections should be implemented based on human input. The identified corrections are applied based on determined criteria while leaving a specified number of errors uncorrected. In some cases, the method 300 may implement a strategy where all errors are corrected except for a specified number of errors per day per human expert left uncorrected. For example, approximately one detected critical error per day may be left uncorrected for each human expert.

With continued reference to FIG. 3, the method 300 then reaches a step 312, which is a decision point that determines whether a human expert detected the intentionally uncorrected error. At step 312, the system determines whether the human expert identified and corrected the predetermined error that was intentionally left uncorrected at step 310.

If the human expert detected the error at step 312, the method 300 proceeds along a Yes branch to a step 314, where successful detection is recorded for performance assessment. The recording of successful detection may be stored and associated with an identifier of the human expert for performance tracking purposes.

If the human expert did not detect the error at step 312, the method 300 proceeds along a No branch to a step 316. At step 316, the error is presented for inspection, an automatically corrected segmentation is shown, and the information is recorded for training purposes. During step 316, if a critical error is intentionally left uncorrected and remains undetected, the error is presented for inspection. The automatically corrected segmentation is shown to the human expert. The critical error is recorded along with an identifier for performance assessment and targeted training purposes.

Categorization of specific error types enables module-based training courses for the improvement of specific error detection. Such module-based training courses may be included as part of continuing education or retraining programs for human experts. In some cases, retraining programs may be initiated after critical errors are detected or after external complaints or feedback are received.

The method 300 may be applied to various clinical applications beyond coronary artery lumen segmentation. In some cases, the method 300 may be applied to plaque detection and characterization. When applied to plaque detection and characterization, the automated process identifies and characterizes coronary plaque composition. The initial model may perform plaque detection and characterization with high accuracy, but not perfectly, and the secondary model may identify and rectify critical errors. The function of the automated method may be to detect lesions with coronary plaque and quantify the amount of each type of plaque. The types of plaque may include calcified plaque, non-calcified plaque, and low attenuation plaque. The responsibility of the human observer may be to review and amend these detections and quantifications.

In some cases, the method 300 may be applied to vessel labeling. In some cases, the method 300 may be applied to large structures segmentation, such as segmentation of the aorta or myocardium. In some cases, the method 300 may be applied to identification of anatomical features, such as occlusions or stents. In some cases, the method 300 may be applied to vessel inclusion. The method 300 provides a framework for introducing predetermined errors and tracking human reviewer performance across these various clinical applications.

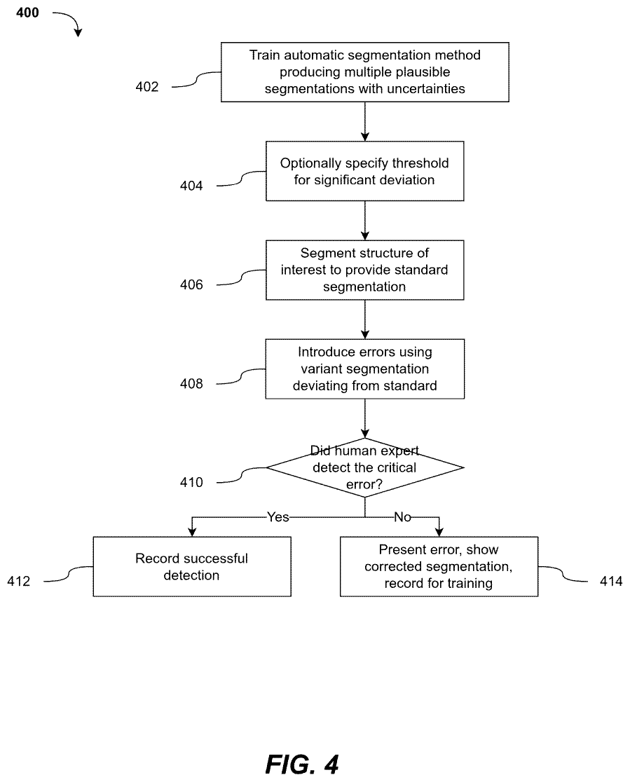

Referring to FIG. 4, a method 400 for enhancing quality control in medical image segmentation using segmentation variability is illustrated. The method 400 provides a structured approach for introducing errors through segmentation variability to assess human performance in reviewing medical image segmentations. The method 400 enables performance assessment and targeted training based on whether critical errors are detected by human experts.

In the method 400, a predetermined error may be introduced by an automatic segmentation method that produces one or more variant segmentations, including one or more implausible segmentations. The automatic segmentation method that produces multiple plausible segmentations may include diffusion models for semantic segmentation, ensembles of segmentation models, Bayesian dropout models, or models which utilize variational approaches. These types of models may generate multiple segmentation outputs for a given input image, with each output representing a plausible segmentation of the structure of interest.

The method 400 begins with a step 402, where an automatic segmentation method is trained to produce multiple plausible segmentations along with uncertainties. During step 402, the automatic segmentation model is trained using annotations provided by human experts, which contain inherent variability. Model and data uncertainty may be computed at inference alongside producing segmentation variants. The training phase of the method 400 comprises training an automatic segmentation model that produces multiple plausible segmentations along with uncertainties.

With continued reference to FIG. 4, the method 400 then proceeds to a step 404, where a threshold for significant deviation is optionally specified. During step 404, a threshold on a relevant metric may be specified to determine whether a variant segmentation deviates significantly from a standard segmentation of the automatic segmentation method. In some cases, the relevant metric may be a Dice score. The threshold may be determined with human input by showing segmentation variants to human experts and labeling the ones with significant errors. Once segmentation variants have been labeled as having significant errors, a threshold on the Dice score may be determined for the segmentation variants that have been labeled as significant errors. This threshold may be used to introduce similar errors automatically in future applications.

Following step 404, the method 400 moves to a step 406, where a structure of interest is segmented to provide a standard segmentation. During step 406, the trained model segments the structure of interest using the automatic segmentation method. In some cases, the standard segmentation may be obtained using averaged segmentations from an ensemble of models. The inference phase of the method 400 comprises segmenting a structure of interest to provide a standard segmentation.

As further shown in FIG. 4, the method 400 then continues to a step 408, where errors are introduced using a variant segmentation that deviates from the standard segmentation. During step 408, errors may be introduced into the predicted segmentation by modifying certain regions to create a segmentation variant that deviates significantly from the standard segmentation. In some cases, a segmentation system that uses an ensemble of N models produces N different segmentation variants. A variant which deviates by at least some threshold from the mean or standard segmentation in a given region may be selected to introduce an error. The inference phase of the method 400 further comprises introducing errors by modifying certain regions to create a segmentation variant that deviates significantly from the standard segmentation.

In some cases, higher uncertainty regions may be targeted to introduce errors. Higher uncertainty regions may be targeted because segmentation variants will deviate more significantly from the standard segmentation in these regions. By targeting higher uncertainty regions, the method 400 may introduce errors that are more challenging for human reviewers to detect, thereby providing a more rigorous assessment of human reviewer performance.

With continued reference to FIG. 4, the method 400 proceeds to a step 410, which is a decision point that determines whether a human expert detected the critical error. At step 410, the system determines whether the human expert identified and corrected the predetermined error that was introduced at step 408.

If the human expert detected the critical error at step 410, the method 400 proceeds along a Yes branch to a step 412, where successful detection is recorded. The recording of successful detection may be stored and associated with an identifier of the human expert for performance tracking purposes.

If the human expert did not detect the critical error at step 410, the method 400 proceeds along a No branch to a step 414. At step 414, the error is presented for inspection, an automatically corrected segmentation is shown, and the information is recorded for training purposes. The error detection and evaluation phase of the method 400 comprises presenting the error for inspection if a critical error is undetected, showing an automatically corrected segmentation, and recording the critical error along with an identifier for performance assessment and targeted training purposes.

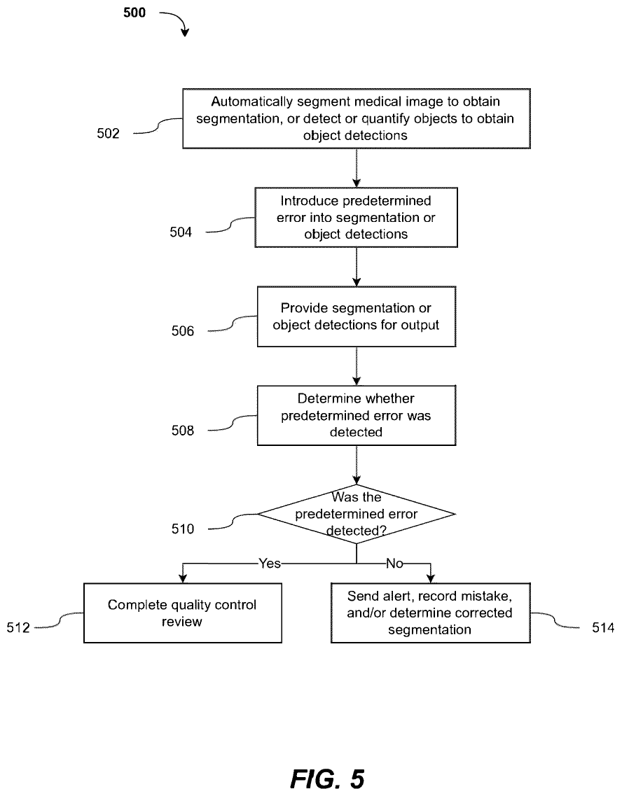

Referring to FIG. 5, a method 500 for enhancing quality control in medical image segmentation using expert knowledge is illustrated. The method 500 provides a structured approach for introducing predetermined errors into medical image segmentations using expert knowledge to modify a segmentation. The method 500 enables performance assessment and targeted training based on whether critical errors are detected by human experts.

The method 500 begins with a step 502, where a medical image is automatically segmented to obtain a segmentation, or objects are detected or quantified to obtain one or more object detections. During step 502, the automatic segmentation may be performed by the processing devices 150 of the server systems 140. The automatic segmentation or object detection may be performed using trained machine learning models or other automated algorithms.

With continued reference to FIG. 5, the method 500 then proceeds to a step 504, where a predetermined error is introduced into the segmentation or one or more object detections. During step 504, the predetermined error may be introduced using expert knowledge to modify the segmentation. The method 500 may comprise a training phase comprising training a standard segmentation model and generating additional segmentations by employing expert or prior knowledge to modify the segmentation model, including one or more geometric models.

In some cases, the one or more geometric models may be based on an idealized radius to disregard regions of stenosis. For example, a lumen wall model based on an idealized radius may be used, causing regions of stenosis, which are relevant for detecting heart disease, to be disregarded and replaced by a gradually decreasing radius, as would be expected in a healthy individual. In some cases, the one or more geometric models may involve omission of critical predictions including calcified plaque in a lumen outer wall segmentation.

The method 500 may comprise an inference phase comprising applying the segmentation model and employing an auxiliary model to introduce critical errors. During the inference phase, the segmentation model is applied, and subsequently, the auxiliary model is employed to introduce critical errors based on the expert or prior knowledge.

Following step 504, the method 500 moves to a step 506, where the segmentation or one or more object detections are provided for output. During step 506, the segmentation or one or more object detections may be presented to a human observer through a display interface. The human observer may be a physician 120, a radiologist, or other medical professional responsible for reviewing the segmentation or object detections.

As further shown in FIG. 5, the method 500 then continues to a step 508, where a determination is made as to whether the predetermined error was detected. During step 508, the system evaluates whether the human observer identified and corrected the predetermined error that was introduced at step 504.

The method 500 proceeds to a step 510, which represents a decision point asking whether the predetermined error was detected. At step 510, the system determines whether the observer detected or corrected the predetermined error.

If the predetermined error was detected at step 510, the method 500 proceeds along a Yes branch to a step 512, where the quality control review is completed. The recording of successful detection may be stored and associated with an identifier of the human observer for performance tracking purposes.

If the predetermined error was not detected at step 510, the method 500 proceeds along a No branch to a step 514. At step 514, an alert is sent, a mistake is recorded, and/or a corrected segmentation is determined. The method 500 may comprise an error detection and evaluation phase comprising presenting the error for examination if a critical error remains undetected, displaying an automatically corrected segmentation, and documenting the critical error along with an identifier for performance assessment and targeted training purposes.

In some cases, the method 500 may introduce critical errors by tracking and undoing significant changes made by human experts as part of a standard human-in-the-loop framework. For a human-in-the-loop framework where a human expert corrects the automatic segmentations provided by a model, the system may track all corrections made by human experts and ensure the system can undo any set of human-made corrections.

Given a human-corrected output, critical errors may be introduced by reverting corrections made in specific regions. In some cases, critical errors may be introduced by reverting corrections where the automatic lumen wall boundary of coronary arteries in cardiac computed tomography angiography (CCTA) was significantly adjusted. In some cases, critical errors may be introduced by reverting corrections where additional coronary segments have been added to an initial automatically extracted centerline tree. In some cases, critical errors may be introduced by reverting corrections where coronary segments have been removed from an initial automatically extracted centerline tree. In some cases, critical errors may be introduced by reverting corrections where an automatically predicted coronary label, such as LAD (left anterior descending), LCx (left circumflex), or RCA (right coronary artery), has been updated to a significantly different path.

In some cases, critical errors may be introduced by reverting corrections where a stenosis severity classification has been modified from the initial automated assessment. In some cases, critical errors may be introduced by reverting corrections where plaque composition characterization has been adjusted, such as changes between calcified, non-calcified, or mixed plaque classifications. In some cases, critical errors may be introduced by reverting corrections where bifurcation points have been repositioned or reclassified in the coronary tree structure.

In some cases, the method 500 may introduce errors by reverting corrections where vessel diameter measurements have been manually adjusted from automated calculations. In some cases, critical errors may be introduced by reverting corrections where lesion length measurements have been modified. In some cases, critical errors may be introduced by reverting corrections where the presence or absence of a chronic total occlusion has been changed from the initial automated detection.

In some cases, the method 500 may introduce errors related to anatomical variant identification. Critical errors may be introduced by reverting corrections where anomalous coronary artery origins have been identified or reclassified. In some cases, critical errors may be introduced by reverting corrections where myocardial bridging segments have been added or removed from the analysis.

In some cases, the method 500 may introduce errors by reverting corrections where stent boundaries have been manually delineated differently from automated detection. In some cases, critical errors may be introduced by reverting corrections where in-stent restenosis regions have been identified or modified. In some cases, critical errors may be introduced by reverting corrections where bypass graft patency assessments have been changed.

In some cases, the method 500 may introduce errors related to image quality assessments. Critical errors may be introduced by reverting corrections where motion artifacts have been flagged or unflagged in specific coronary segments. In some cases, critical errors may be introduced by reverting corrections where segments have been marked as non-evaluable due to blooming artifacts from calcification.

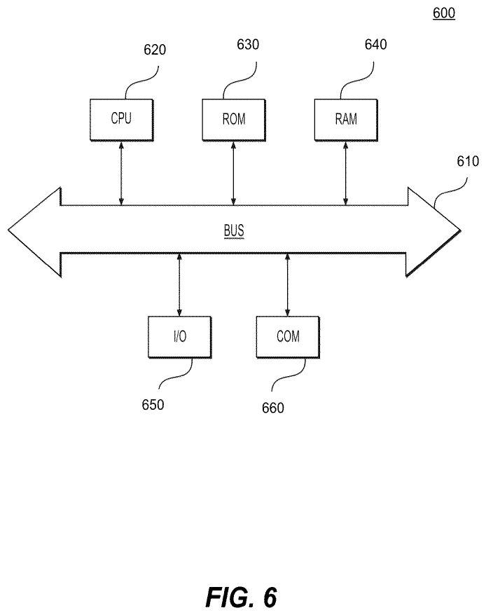

Referring to FIG. 6, a system 600 for enhancing quality control in medical image segmentation is illustrated. The system 600 includes a processor 620, a read-only memory 630, a random access memory 640, an input output interface 650, and a communication interface 660, all connected via a bus 610. The bus 610 facilitates data transfer and communication between the various components of the system 600. The bus 610 is depicted as a bidirectional connection between all components, indicating that data may flow in both directions between the processor 620, read-only memory 630, random access memory 640, input output interface 650, and communication interface 660.

With continued reference to FIG. 6, the processor 620 executes instructions and performs computations for implementing the quality control enhancement methods described herein. The processor 620 may comprise one or more processors. In some cases, the processor 620 may be implemented as a plurality of processors distributed among a plurality of computing devices. The processor 620 may execute instructions stored in the read-only memory 630 or the random access memory 640 to perform the automatic segmentation, error introduction, and error detection operations described herein.

As further shown in FIG. 6, the read-only memory 630 stores firmware and permanent data that the processor 620 may access during operation. The read-only memory 630 may store instructions for initializing the system 600 and for performing baseline operations. The random access memory 640 provides temporary storage for data and instructions being actively processed by the processor 620. The random access memory 640 may store medical images, segmentation data, error tracking information, and intermediate computational results during the quality control enhancement operations.

The input output interface 650 enables the system 600 to receive input data and to output results. In some cases, the input output interface 650 may receive medical images from various imaging modalities, such as computed tomography, magnetic resonance imaging, or ultrasound. In some cases, the input output interface 650 may output segmentations, object detections, alerts, and performance assessment data. The input output interface 650 may be connected to display devices for presenting segmentations and errors to human observers.

With continued reference to FIG. 6, the communication interface 660 allows the system 600 to communicate with external devices and networks. The communication interface 660 may enable the transmission and reception of patient-specific information and imaging data over an electronic network. In some cases, the communication interface 660 may facilitate communication with physicians, third party providers, and other healthcare facilities for receiving medical images and transmitting quality control results.

The system 600 for enhancing quality control in medical image segmentation comprises one or more processors and a memory storing instructions. The memory may comprise the read-only memory 630 and/or the random access memory 640. When executed by the one or more processors, the instructions cause the system 600 to automatically segment a medical image to obtain a segmentation, or detect or quantify objects in the medical image to obtain one or more object detections. The instructions further cause the system 600 to introduce a predetermined error into the segmentation or one or more object detections.

As further shown in FIG. 6, the instructions stored in the memory cause the system 600 to provide the segmentation or one or more object detections for output. The output may be provided through the input output interface 650 to a display device for presentation to a human observer. The instructions further cause the system 600 to determine whether the predetermined error was detected in the segmentation or one or more object detections. The determination may be made by comparing corrections or modifications made by the human observer to the known location and type of the predetermined error.

The instructions stored in the memory cause the system 600 to send an alert, record a mistake, and/or determine a corrected segmentation if the predetermined error is not detected. In some cases, the alert may be sent through the input output interface 650 or the communication interface 660. In some cases, the mistake may be recorded in the random access memory 640 or transmitted to external storage through the communication interface 660. In some cases, the corrected segmentation may be determined by the processor 620 and presented to the human observer through the input output interface 650.

In some cases, the system 600 may introduce the predetermined error using a secondary segmentation model trained to predict locations and types of corrections required. The secondary segmentation model may be stored in the read-only memory 630 or the random access memory 640 and executed by the processor 620. The secondary segmentation model may be trained using collected expert correction data to emulate the behavior of human experts in focusing on critical error correction.

In some cases, the system 600 may introduce the predetermined error by an automatic segmentation method that produces one or more variant segmentations, including one or more implausible segmentations. The automatic segmentation method may include diffusion models for semantic segmentation, ensembles of segmentation models, Bayesian dropout models, or models which utilize variational approaches. The processor 620 may execute the automatic segmentation method to generate multiple segmentation variants and select a variant that deviates from a standard segmentation to introduce an error.

In some cases, the system 600 may introduce the predetermined error using expert knowledge to modify a segmentation. The expert knowledge may include using one or more geometric models based on an idealized radius to disregard regions of stenosis. In some cases, the expert knowledge may include omission of critical predictions including calcified plaque in a lumen outer wall segmentation. The processor 620 may apply auxiliary models based on expert knowledge to introduce critical errors into segmentations.

In some cases, the instructions stored in the memory further cause the system 600 to record the predetermined error along with an identifier for performance assessment and targeted training purposes. The identifier may identify the human observer who reviewed the segmentation or object detections. The recorded information may be stored in the random access memory 640 or transmitted through the communication interface 660 to external storage for subsequent analysis and training program development.

A non-transitory computer-readable medium may store instructions that, when executed by one or more processors, cause the one or more processors to perform the quality control enhancement methods described herein. The non-transitory computer-readable medium may comprise the read-only memory 630, the random access memory 640, or other storage media such as hard disk drives, solid-state drives, or optical media.

The instructions stored on the non-transitory computer-readable medium, when executed by one or more processors, cause the one or more processors to automatically segment a medical image to obtain a segmentation, or detect or quantify objects in the medical image to obtain one or more object detections. The instructions further cause the one or more processors to introduce a predetermined error into the segmentation or one or more object detections. The instructions cause the one or more processors to provide the segmentation or one or more object detections for output.

The instructions stored on the non-transitory computer-readable medium further cause the one or more processors to determine whether the predetermined error was detected in the segmentation or one or more object detections. If the predetermined error is not detected, the instructions cause the one or more processors to send an alert, record a mistake, and/or determine a corrected segmentation. The non-transitory computer-readable medium may be implemented as part of the system 600 or as a separate storage medium that may be connected to a computing device for execution of the stored instructions.

A number of implementations have been described. Nevertheless, it will be understood that various modifications may be made without departing from the spirit and scope of the disclosure. Accordingly, other implementations are within the scope of the following claims.

1. A method for enhancing quality control in medical image segmentation, comprising:
automatically segmenting a medical image to obtain a segmentation, or detecting or quantifying objects in the medical image to obtain one or more object detections;
introducing a predetermined error into the segmentation or one or more object detections;
providing the segmentation or one or more object detections for output;
determining whether the predetermined error was detected in the segmentation or one or more object detections; and
if the predetermined error is not detected, sending an alert, recording a mistake, and/or determining a corrected segmentation.

2. The method of claim 1, wherein the predetermined error is introduced using a secondary segmentation model trained to predict locations and types of corrections required.

3. The method of claim 2, further comprising a training phase comprising:
training an initial automatic segmentation model to achieve accuracy beyond a predetermined threshold in segmenting a structure of interest;
defining a process and training one or more administrators to identify and correct critical errors;
collecting data of captured instances where the administrators correct critical errors; and
training the secondary segmentation model using the collected data to predict the locations and types of corrections required.

4. The method of claim 3, further comprising an inference phase comprising:
segmenting the structure of interest using the initial automatic segmentation model to create an initial segmentation;
applying the secondary segmentation model to identify areas where the initial segmentation requires improvement;
determining which corrections to implement based on human input; and
applying the corrections based on determined criteria while leaving a specified number of errors uncorrected.

5. The method of claim 4, further comprising an error detection and evaluation phase comprising:
if an error is intentionally left uncorrected and remains undetected, presenting the error for inspection;
showing an automatically corrected segmentation; and
recording the error along with an identifier for performance assessment and targeted training purposes.

6. The method of claim 1, wherein the predetermined error is introduced by an automatic segmentation method that produces one or more variant segmentations, including one or more implausible segmentations.

7. The method of claim 6, further comprising a training phase comprising:
training an automatic segmentation model that produces multiple plausible segmentations along with uncertainties.

8. The method of claim 1, further comprising an inference phase comprising:
segmenting a structure of interest to provide a standard segmentation; and
introducing errors by modifying certain regions to create a segmentation variant that deviates significantly from the standard segmentation.

9. The method of claim 8, further comprising an error detection and evaluation phase comprising:
if an error is undetected, presenting the error for inspection;
showing an automatically corrected segmentation; and
recording the error along with an identifier for performance assessment and targeted training purposes.

10. The method of claim 1, wherein the predetermined error is introduced using expert knowledge to modify a segmentation.

11. The method of claim 10, further comprising a training phase comprising:
training a standard segmentation model; and
generating additional segmentations by employing expert or prior knowledge to modify the standard segmentation model, including one or more geometric models.

12. The method of claim 11, wherein the one or more geometric models are based on an idealized radius to disregard regions of stenosis, or omission of critical predictions including calcified plaque in a lumen outer wall segmentation.

13. The method of claim 11, further comprising an inference phase comprising:
applying the standard segmentation model; and
employing an auxiliary model to introduce critical errors.

14. The method of claim 12, further comprising an error detection and evaluation phase comprising:
if an error remains undetected, presenting the error for examination;
displaying an automatically corrected segmentation; and
documenting the error along with an identifier for performance assessment and targeted training purposes.

15. A system for enhancing quality control in medical image segmentation, comprising:
one or more processors; and
a memory storing instructions that, when executed by the one or more processors, cause the system to:
automatically segment a medical image to obtain a segmentation, or detect or quantify objects in the medical image to obtain one or more object detections;
introduce a predetermined error into the segmentation or one or more object detections;
provide the segmentation or one or more object detections for output;
determine whether the predetermined error was detected in the segmentation or one or more object detections; and
if the predetermined error is not detected, send an alert, record a mistake, and/or determine a corrected segmentation.

16. The system of claim 15, wherein the predetermined error is introduced using a secondary segmentation model trained to predict locations and types of corrections required.

17. The system of claim 15, wherein the predetermined error is introduced by an automatic segmentation method that produces one or more variant segmentations, including one or more implausible segmentations.

18. The system of claim 15, wherein the predetermined error is introduced using expert knowledge to modify a segmentation, including using one or more geometric models based on an idealized radius to disregard regions of stenosis, or omission of critical predictions including calcified plaque in a lumen outer wall segmentation.

19. The system of claim 15, wherein the instructions further cause the system to record the predetermined error along with an identifier for performance assessment and targeted training purposes.

20. A non-transitory computer-readable medium storing instructions that, when executed by one or more processors, cause the one or more processors to:
automatically segment a medical image to obtain a segmentation, or detect or quantify objects in the medical image to obtain one or more object detections;
introduce a predetermined error into the segmentation or one or more object detections;
provide the segmentation or one or more object detections for output;
determine whether the predetermined error was detected in the segmentation or one or more object detections; and
if the predetermined error is not detected, send an alert, record a mistake, and/or determine a corrected segmentation.
